(19) United States
(12) Patent Application Publication
(10) Pub. No.: US 2013/0327884 A1
(43) Pub. Date: Dec. 12, 2013

(54) DEVICE FOR BRAKING AND ROTATING AN AIRCRAFT WHEEL

(71) Applicant: Jean-Marc Yiu, Velizy-Villacoublay (FR)

(72) Inventor: Jean-Marc Yiu, Velizy-Villacoublay (FR)

(73) Assignee: MESSIER-BUGATTI-DOWTY, Velizy-Villacoublay (FR)

(21) Appl. No.: 13/979,925

(22) PCT Filed: Jan. 19, 2012
(86) PCT No.: PCT/EP2012/050805

§ 371 Date: Aug. 26, 2013

(30) Foreign Application Priority Data
Jan. 21, 2011 (FR) 1150508

(51) Int. Cl. B64C 25/40

(52) U.S. Cl. CPC B64C 25/405
USPC 244/50

(57) ABSTRACT

The invention relates to a device for braking and driving rotation of a wheel (1) mounted to rotate on an aircraft landing gear axle, the device comprising: a torsion tube (26) adapted to be mounted to rotate on the axle that carries the wheel; a stack of disks (30) including first disks having means for constraining them in rotation with the wheel and second disks arranged in alternation with the first disks and including means for constraining them in rotation with the torsion tube; a ring (23) carrying braking actuators (24) that are adapted to act selectively to press the disks against one another, the ring being constrained in rotation with the torsion tube in order to form a rotary portion (20) of the device; a rotary drive member (40) for driving rotation of the rotary portion (20); and finally blocking means (51, 52) for selectively blocking rotation of the rotary portion, which means are independent of the rotary drive member.

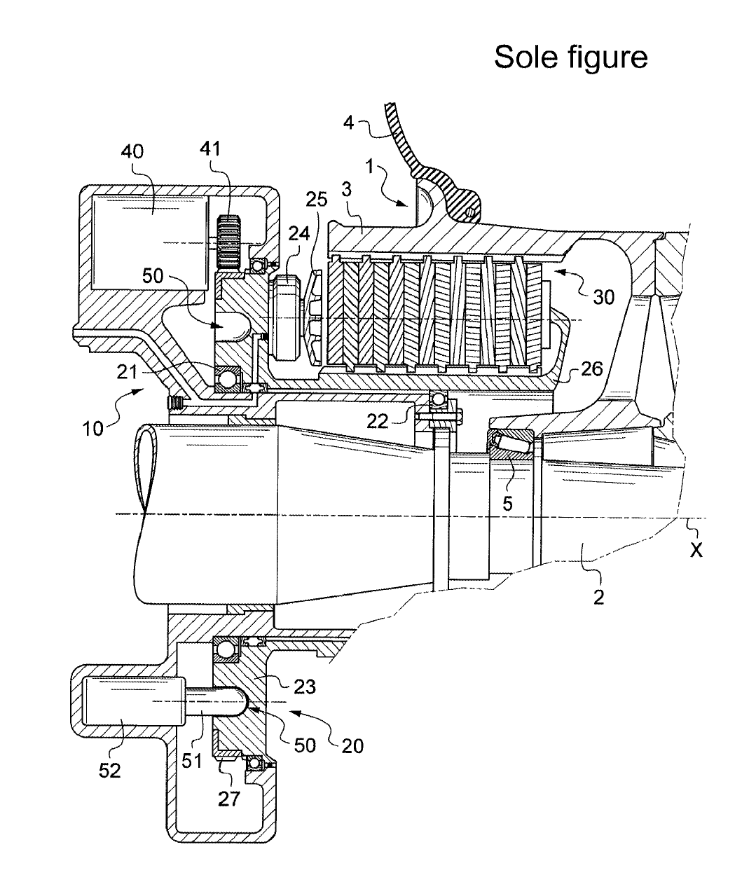

The invention relates to a device for braking and driving rotation of an aircraft wheel.

### TECHNOLOGICAL BACKGROUND OF THE INVENTION

Document U.S. Pat. No. 3,977,631 describes landing gear including at least one axle rotatably carrying a wheel that is fitted with a brake. The brake comprises a stack of disks, some of which constrained in rotation with the wheel and others of which, arranged in alternation with the first disks, are constrained in rotation with a torsion tube. The torsion tube is itself mounted to rotate on the axle and is constrained in rotation with a ring that carries braking actuators.

The ring is selectively driven in rotation or blocked by means of an electric motor. Thus, by actuating the braking actuators so that the disks are pressed against one another, while also actuating the electric motor, the ring is secured to the wheel and the electric motor drives the wheel in rotation, thereby enabling the aircraft to be moved without using its engines.

In contrast, by blocking the motor, the ring is held stationary and the brake can then be used for braking the wheel. Nevertheless, it is necessary for the motor to be dimensioned to be capable of withstanding the maximum braking torque, which may lead to using a motor of large size and weight. In addition, in the event of the motor failing, the braking function is lost, since it is no longer possible to block the ring.

### OBJECT OF THE INVENTION

An object of the invention is to provide a device for braking and driving rotation of an aircraft wheel in which a failure of the rotary drive motor does not undermine the braking function.

### BRIEF DESCRIPTION OF THE INVENTION

In order to achieve this object, the invention provides a device for braking and driving rotation of a wheel mounted to rotate on an aircraft landing gear axle, the device comprising:
a torsion tube adapted to be mounted to rotate on the axle that carries the wheel;
a stack of disks including first disks having means for constraining them in rotation with the wheel and second disks arranged in alternation with the first disks and including means for constraining them in rotation with the torsion tube;
a ring carrying braking actuators that are adapted to act selectively to press the disks against one another, the ring being constrained in rotation with the torsion tube in order to form a rotary portion of the device; and
a rotary drive member for driving rotation of the rotary portion.

According to the invention, the device also includes blocking means for selectively blocking rotation of the rotary portion, which means are independent of the rotary drive member.

Thus, when the ring is to be blocked in order to enable the wheel to be braked, the blocking means enable the ring to be blocked without assistance from the motor. Furthermore, the motor is not subjected to the braking torque which is taken up by the blocking means. Also, in the event of the motor failing, the blocking means nevertheless enable the ring to be prevented from rotating so as to allow the aircraft to be braked.

### BRIEF DESCRIPTION OF THE FIGURE

The invention can be better understood in the light of the following description of a particular embodiment of the invention given with reference to the accompanying FIGURE, which is a fragmentary section view of a device for braking and driving rotation of a wheel mounted on landing gear, in a particular embodiment of the invention.

### DETAILED DESCRIPTION OF THE INVENTION

The invention is described herein with reference to a wheel 1 mounted to rotate on a landing gear axle 2. The wheel 1 comprises a rim 3 carrying a tire 4 and mounted on the axle by means of rolling bearings 5 (only one of which is shown in the FIGURE) so as to rotate about an axis of rotation X.

The device of the invention comprises a base 10 that is mounted around the axle 2 and that is prevented from rotating by stop means (not shown). For example, the base 10 may be fastened to a collar of the axle 2.

A rotary portion 20 is mounted on the base 10 to rotate about it via rolling bearings 21 and 22. The rotary portion 20 comprises a ring 23 carrying braking actuators 24, constituted in this example by hydraulic actuators, each having an axially movable piston 25. The rotary portion 20 also has a torsion tube 26 that extends inside the rim 3. Between the rim 3 and the torsion tube 26 there extends a stack of disks 30 comprising in alternation first disks that are constrained in rotation with the rim 3 and second disks that are constrained in rotation with the torsion tube 26. The braking actuators 24 are adapted to press the disks 30 selectively against one another.

The rotary portion 20 carries a toothed wheel 27 cooperating with a gearwheel 41 carried at the end of the shaft of a drive motor 40 carried by the base 10. Thus, rotation of the gearwheel 41 under drive from the motor 40 causes the rotary portion 20 to rotate. It then suffices to actuate the braking actuators 24 so as to press the disks 30 against one another so as to constrain the wheel 1 in rotation with the rotary portion 20 and thus rotate the wheel 1. This serves to cause the aircraft to move without having recourse to its engines.

In order to use the device of the invention for braking the wheel, it is appropriate on the contrary to prevent the rotary portion 20 from rotating. To do this, and according to the invention, the device is provided with blocking means that are independent of the motor 40 for driving rotation, and that comprise, in this example:
cavities 50 formed in a face of the ring 23 and regularly distributed along a circumference thereof; and
a blocking actuator 52 secured to the base 10 and including a finger 51 that is movable in a direction parallel to the axis of rotation X between an extended position, as shown, into which it is urged by a spring member internal to the actuator, and in which it is suitable for penetrating into one of the cavities 50, and a retracted position, into which it is placed by the actuator when it is desired to allow the motor 40 to drive the rotary portion in rotation.

Thus, in the normal state, the movable finger is urged towards the ring 23 and blocks it from rotating as soon as a cavity 50 comes into register with the finger 51. It is possible to neutralize such blocking by causing the finger 51 to be retracted, thereby releasing the rotary portion 20. The operation of the device of the invention is as follows:
when it is desired to brake the wheel 1, the power supply to the drive motor 40 and to the blocking actuator 52 is switched off. The finger 51 is then automatically urged towards the ring 23. On first braking, the ring 23 turns until one of its cavities 50 comes into register with the finger that, under drive from the associated spring, then penetrates into the cavity in order to block rotation of the rotary portion 20. Braking torque is then taken up by the finger 51 without the motor 40 being subjected to that torque; and
when it is desired to cause the wheel 1 to rotate, the drive motor 40 is powered, as is the blocking actuator 52. This causes the finger 51 to be retracted, thereby neutralizing the blocking means and thus releasing the rotary portion 20, which can then rotate under drive from the drive motor 40. It then suffices to cause the braking actuators 24 to operate in order to cause the wheel 1 to rotate.

Thus, during braking stages, the drive motor 40 is not subjected to braking torque. Furthermore, the blocking of the rotary portion 20 is automatic because of the finger 51 being urged resiliently towards the ring 23. Thus, a failure of the drive motor 40 cannot prevent the wheel from being braked. Naturally, the invention is not limited to the above description, but on the contrary covers any variant coming within the ambit defined by the claims.

In particular, although the device in the example shown has a stationary base that is fastened to the axle, the base could be constituted directly by the axle or by a portion of the landing gear carrying the axle.

Although in the example shown the blocking member is a finger that is movable axially and that penetrates into cavities that are circumferentially distributed on a face of the ring, it would be possible to use other types of blocking member, such as a finger that is movable radially to penetrate into cavities formed in an outside face of the ring, or indeed a dog clutch.

Although in the example shown the braking actuators are hydraulic, they could be of the electromechanical type. Likewise, the rotary drive member 40 and the blocking member could be hydraulic or electromechanical.

Although as described the ring is made integrally with the torsion tube, it would naturally be possible to provide for those two elements to be fabricated separately and then constrained to rotate together.

1. A device for braking and driving rotation of a wheel (1) mounted to rotate on an aircraft landing gear axle, the device comprising:
a torsion tube (26) adapted to be mounted to rotate on the axle that carries the wheel;
a stack of disks (30) including first disks having means for constraining them in rotation with the wheel and second disks arranged in alternation with the first disks and including means for constraining them in rotation with the torsion tube;
a ring (23) carrying braking actuators (24) that are adapted to act selectively to press the disks against one another, the ring being constrained in rotation with the torsion tube in order to form a rotary portion (20) of the device; and
a rotary drive member (40) for driving rotation of the rotary portion (20);
the device being characterized in that it also includes blocking means (51, 52) for selectively blocking rotation of the rotary portion, which means are independent of the rotary drive member.

2. A device according to claim 1, wherein the blocking means are arranged to present a normal state in which they tend to block rotation of the rotary portion (20) and a neutralized state into which they can be placed under control, and in which they leave the rotary portion (20) free to be driven selectively in rotation by the rotary drive member (40).

3. A device according to claim 1, wherein the blocking means comprise a movable finger (51) facing the rotary portion and urged towards it in order to penetrate selectively into at least one cavity (50) in the rotary portion when the cavity is in register with the finger.
